(19) United States
(12) Patent Application Publication
(10) Pub. No.: US 2026/0249894 A1
(43) Pub. Date: Aug. 27, 2026

(54) Motorized Electric Cart Device

(71) Applicant: Anthony Fama, Cairnbrook, PA (US)

(72) Inventor: Anthony Fama, Cairnbrook, PA (US)

(21) Appl. No.: 19/191,362

(22) Filed: Apr. 28, 2025

Related U.S. Application Data
(60) Provisional application No. 63/761,209, filed on Feb. 21, 2025.

(51) Int. Cl. B62B 5/00; B62B 5/04; B62B 5/06; B66D 3/04

(52) U.S. Cl. CPC B62B 5/0046; B62B 5/0053; B62B 5/0069; B62B 5/0079; B62B 5/04; B62B 5/06; B66D 3/04

(57) ABSTRACT

The device is comprised of a motorized electric cart designed to assist users in transporting loads, objects, etc. The device is comprised of a frame with large rear wheels and 360-degree pivoting front wheel with locking mechanism for stability. A handle with textured grip allows comfortable steering, while high-torque electric motor provides powered assistance through handle-mounted control system with adjustable speed modes. A rechargeable lithium-ion battery housed in weather-resistant compartment supplies power, with an LED indicator displaying battery status. Additional features include winch system for lifting heavy loads onto the frame, retractable support stand for stability, and removable anchor points for secure cargo transport. Built-in tow hitch also allows attachment to ATVs or UTVs, while optional side rail extensions increase carrying capacity. By integrating these elements, the motorized electric cart enhances mobility, reduces physical strain, and ensures efficient transport for outdoor enthusiasts, hunters, farmers, and heavy-duty applications.

### CROSS-REFERENCE TO RELATED APPLICATION

The present application claims priority to, and the benefit of, U.S. Provisional Application No. 63/761,209, which was filed on February 21, 2025, and is incorporated herein by reference in its entirety.

### FIELD OF THE INVENTION

The present invention relates generally to the field of carts. More specifically, the present invention relates to a motorized electric cart that assists in transporting heavy loads. Accordingly, the present disclosure makes specific reference thereto. Nonetheless, it is to be appreciated that aspects of the present invention are also equally applicable to other like applications, devices, and methods of manufacture.

### BACKGROUND

Transporting heavy game, equipment, or supplies across rugged outdoor environments presents significant challenges for hunters, outdoor enthusiasts, and workers in various industries. Traditional carts and manual lifting methods often require substantial physical effort and, in many cases, the assistance of multiple individuals. Hunters, for example, may struggle to transport felled game through dense forests or over uneven terrain without help. Similarly, individuals engaged in gardening, lawn care, or maintenance work often face inefficiencies when moving tools and materials between storage areas and work sites. The time-consuming nature of manually transporting equipment can lead to frustration and reduced productivity. Conventional pull carts and non-motorized transport solutions lack the necessary power and maneuverability to navigate difficult landscapes efficiently. Moreover, the absence of built-in lifting mechanisms forces users to rely on external hoists or additional labor to load heavy items onto transport devices. These limitations create a demand for a more efficient, self-sufficient means of transporting heavy loads in various outdoor settings.

Therefore, there exists a long-felt need in the art for a motorized electric cart device that enables individuals to transport heavy loads independently across outdoor terrains. There also exists a long-felt need in the art for a motorized electric cart device that incorporates a built-in lifting mechanism to facilitate the loading and unloading of large or heavy items. Moreover, there exists a long-felt need in the art for a motorized electric cart device that enhances mobility and reduces physical strain through an integrated motorized drive system.

The subject matter disclosed and claimed herein, in one embodiment thereof, comprises a motorized electric cart device. The device is comprised of a motorized electric cart designed to assist users in transporting loads, objects, etc. The device is comprised of a frame with large rear wheels and a 360-degree pivoting front wheel with a locking mechanism for stability. A handle with a textured grip allows comfortable steering, while a high-torque electric motor provides powered assistance through a handle-mounted control system with adjustable speed modes. A rechargeable lithium-ion battery housed in a weather-resistant compartment supplies power, with an LED indicator displaying battery status. Additional features include a winch system for lifting heavy loads onto the frame, a retractable support stand for stability, and removable anchor points for secure cargo transport. A built-in tow hitch also allows attachment to ATVs or UTVs, while optional side rail extensions increase carrying capacity. By integrating these elements, the motorized electric cart enhances mobility, reduces physical strain, and ensures efficient transport for outdoor enthusiasts, hunters, farmers, and heavy-duty applications.

In this manner, the motorized electric cart device of the present invention accomplishes all the forgoing objectives and provides a battery-powered cart designed to assist users in carrying heavy loads over challenging terrain. The inclusion of a winch and pulley system further allows users to efficiently load and unload items without additional assistance, improving convenience and safety. The motorized drive system, powered by a high-torque electric motor, enhances maneuverability and reduces physical exertion by propelling the cart forward, even on rough or inclined surfaces. Furthermore, the adjustable handle controls and multiple speed modes provide users with customizable operation, ensuring ease of use in various conditions. By integrating these features, the motorized electric cart device significantly reduces the effort required to transport game, tools, and other heavy objects, making it an effective and versatile solution for hunters, homeowners, maintenance workers, and outdoor professionals.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized electric cart device designed to assist users in carrying supplies, game, or heavy loads across rugged outdoor terrains. The device is comprised of a metal frame with a bottom wall and optional side walls that may be fixedly or removably attached.

The device is further comprised of at least one, preferably two, large rear wheels optimized for on-road or off-road travel. A front wheel is capable of 360-degree pivoting and may include a locking mechanism, such as a pin-lock system or electronic brake, for stability on steep or uneven terrain.

A handle is attached to the frame for steering and may include a textured grip for comfort. In one embodiment, the handle is telescopic and adjustable in height to accommodate different user preferences.

The device is also comprised of a motorized drive system powered by a high-torque electric motor that delivers power to the rear wheels. A handle-mounted control, such as a lever, button, or throttle, regulates speed and acceleration. Multiple speed modes allow users to adjust power output based on terrain, load weight, and preference.

A rechargeable lithium-ion battery supplies power to the drive system. The battery is housed in a weather-resistant compartment for protection against moisture, dust, and impact. An LED battery level indicator provides real-time power status.

For additional functionality, the device includes a winch system for lifting, loading, and unloading heavy items. The winch can be manually operated via a hand crank and pulley or through a motorized mechanism controlled by handle-mounted buttons. A retractable support stand stabilizes the cart during winching operations. Removable anchor points along the frame allow for secure cargo attachment. The winch system includes a cable and fasteners such as loops, clips, or clamps for attaching to various objects.

The cart is further comprised of a built-in tow hitch for attachment to ATVs, UTVs, or other vehicles, with a quick-release mechanism for tool-free attachment and detachment.

Accordingly, the motorized electric cart device of the present invention is particularly advantageous as it provides a battery-powered cart designed to assist users in carrying heavy loads over challenging terrain. The inclusion of a winch and pulley system further allows users to efficiently load and unload items without additional assistance, improving convenience and safety. The motorized drive system, powered by a high-torque electric motor, enhances maneuverability and reduces physical exertion by propelling the cart forward, even on rough or inclined surfaces. Furthermore, the adjustable handle controls and multiple speed modes provide users with customizable operation, ensuring ease of use in various conditions. By integrating these features, the motorized electric cart device significantly reduces the effort required to transport game, tools, and other heavy objects, making it an effective and versatile solution for hunters, homeowners, maintenance workers, and outdoor professionals. In this manner, the motorized electric cart device overcomes the limitations of existing devices and methods known in the art used for heavy game, equipment, or supplies.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a motorized electric cart device of the present invention in accordance with the disclosed architecture;

FIG. 2 illustrates an enhanced perspective view of a pulley system of one potential embodiment of a motorized electric cart device of the present invention in accordance with the disclosed architecture; and

FIG. 3 illustrates an enhanced perspective view of a cable of one potential embodiment of a motorized electric cart device of the present invention in accordance with the disclosed architecture.

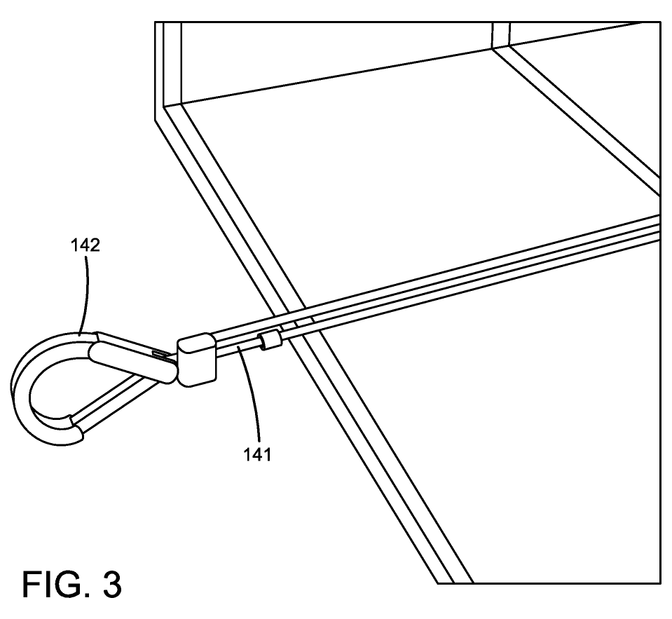

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a motorized electric cart device that enables individuals to transport heavy loads independently across outdoor terrains. There also exists a long-felt need in the art for a motorized electric cart device that incorporates a built-in lifting mechanism to facilitate the loading and unloading of large or heavy items. Moreover, there exists a long-felt need in the art for a motorized electric cart device that enhances mobility and reduces physical strain through an integrated motorized drive system.

The present invention, in one exemplary embodiment, is comprised of a motorized electric cart device designed to assist users in transporting supplies, game, or heavy loads across rugged outdoor terrains. The device is comprised of a metal frame with a bottom wall and optional side walls that may be fixedly or removably attached.

The device is further comprised of at least one, preferably two, large rear wheels optimized for both on-road and off-road travel. A front wheel is designed for 360-degree pivoting and may include a locking mechanism, such as a pin-lock system or electronic brake, to enhance stability on steep or uneven terrain.

A handle is attached to the frame for steering and may include a textured grip for enhanced comfort. In one embodiment, the handle is telescopic and adjustable in height to accommodate different user preferences.

The device is also comprised of a motorized drive system powered by a high-torque electric motor that provides power to the rear wheels. A handle-mounted control, such as a lever, button, or throttle, allows users to regulate speed and acceleration. Multiple speed modes enable users to adjust power output based on terrain, load weight, and operational preference.

A rechargeable lithium-ion battery powers the drive system and is securely housed in a weather-resistant compartment for protection against moisture, dust, and impact. An LED battery level indicator provides real-time power status.

For added functionality, the device includes a winch system designed for lifting, loading, and unloading heavy items. The winch can be manually operated through a hand crank and pulley or through a motorized mechanism controlled via handle-mounted buttons. A retractable support stand stabilizes the cart during winching operations, while removable anchor points along the frame allow for secure cargo attachment. The winch system includes a cable and fasteners such as loops, clips, or clamps to accommodate various attachment needs.

The cart is further comprised of a built-in tow hitch for connection to ATVs, UTVs, or other vehicles, with a quick-release mechanism for tool-free attachment and detachment.

As a result, the motorized electric cart device offers significant advantages by providing a battery-powered transport solution for carrying heavy loads over challenging terrain. The integrated winch and pulley system enables users to efficiently load and unload items without additional assistance, enhancing convenience and safety. The motorized drive system, powered by a high-torque electric motor, improves maneuverability and reduces physical exertion by propelling the cart forward, even on rough or inclined surfaces. Additionally, the adjustable handle controls and multiple speed modes allow for customizable operation, ensuring ease of use across various conditions. By incorporating these features, the motorized electric cart device minimizes the effort required for transporting game, tools, and other heavy objects, making it an effective and versatile solution for hunters, homeowners, maintenance workers, and outdoor professionals. In this manner, the device overcomes the limitations of existing methods and devices used for transporting heavy game, equipment, or supplies.

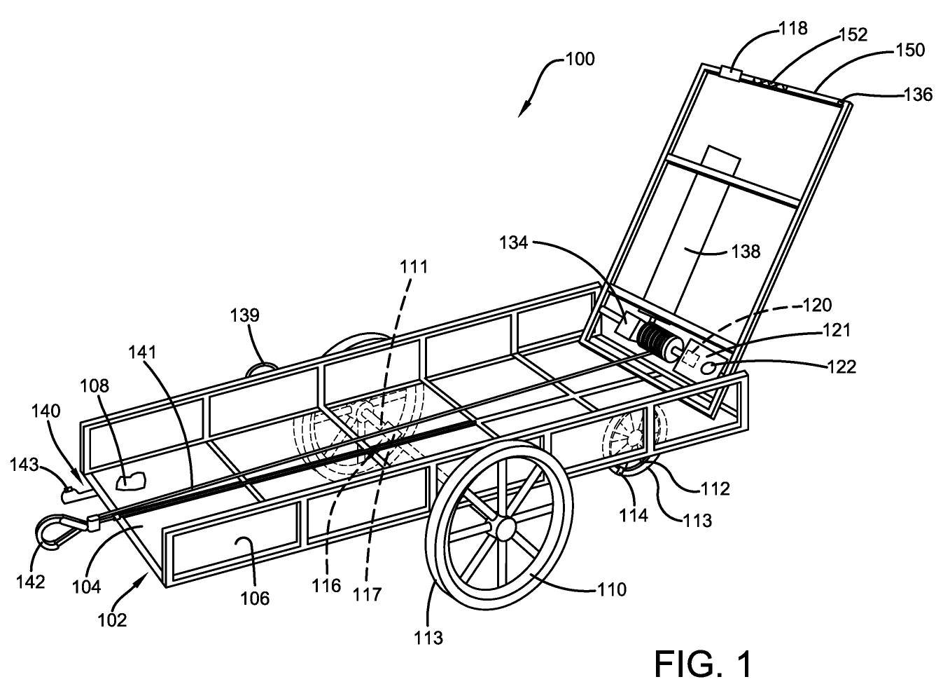

Referring initially to the drawings, FIG. 1 illustrates a perspective view of one potential embodiment of a motorized electric cart device 100 of the present invention in accordance with the disclosed architecture. The motorized electric cart device 100 is an electric-powered transport cart designed to assist individuals in carrying supplies, game, or heavy loads across challenging outdoor terrains. As a result, the device 100 provides a safe, efficient, and easy-to-use solution for outdoor activities such as hunting, fishing, camping, farming, and general hauling.

The motorized electric cart device 100 is comprised of a metal frame 102. The frame 102 is comprised of a bottom wall 104 and may be comprised of two side walls 106 that may be fixedly or removably attached to the bottom wall 104 in various embodiments. The frame 102 may be comprised of a corrosion-resistant coating 108 to protect against moisture, dirt, and extreme weather conditions, ensuring long-term durability.

The device 100 is further comprised of at least one, but preferably two, large rear wheels 110. The wheels 110 may be any type of wheels optimized for on-road or off-road travel, such as but not limited to pneumatic, solid rubber, or all-terrain tires. The rear wheels 110 may be connected by and/or be each comprised of an independent suspension system 111 designed to absorb shocks and vibrations, providing smoother movement over uneven landscapes. The rear wheels 110 are positioned to provide high ground clearance, allowing the device 100 to maneuver over rocks, roots, and other obstacles commonly found in outdoor environments. The device 100 is further comprised of a front wheel 112 that can pivot 360 degrees relative to a vertical axis of the wheel 112/the device 100 (as the wheel 112/Device 100 is shown in FIG. 1). The front wheel 112 may also be comprised of a locking mechanism 114, such as but not limited to a pin-lock system or electronic brake, to lock rotation of the front wheel 112 to provide stability when traversing steep inclines or uneven terrain. The tires 113 of the front wheel 112 and rear wheels 110 are comprised of a puncture-resistant material to reduce maintenance and improve longevity.

The device 100 is further comprised of a handle 150 that is attached to the frame 102 for steering. The handle 150 may be comprised of a textured grip 152 (that may be made of a non- slip material such as but not limited to rubber in one embodiment)to enhance user comfort during extended use. In one embodiment, the handle 150 is a telescopic handle that is adjustable in height to accommodate different user preferences and improve overall ease of use.

The device 100 is also comprised of a motorized drive system 116 that assists users in transporting heavy loads with minimal physical effort. The motorized system 116 is powered by a high-torque electric motor 117 (as seen in FIG. 1) that delivers consistent power output to the rear wheels 110. The motorized system 116 is activated via a handle-mounted control 118, such as but not limited to a lever, button, or throttle, allowing users to regulate speed and acceleration. The drive system 116 may have multiple speed modes, enabling users to adjust power output based on terrain conditions, load weight, and user preference.

A rechargeable lithium-ion battery 120 supplies power to the motorized drive system 116. The battery 120 is securely housed in a weather-resistant battery compartment 121 to protect against moisture, dust, and impact. The battery 120 and/or any other part of the device 100 is comprised of an LED battery level indicator 122 to provide real-time power status, ensuring users are aware of remaining battery life.

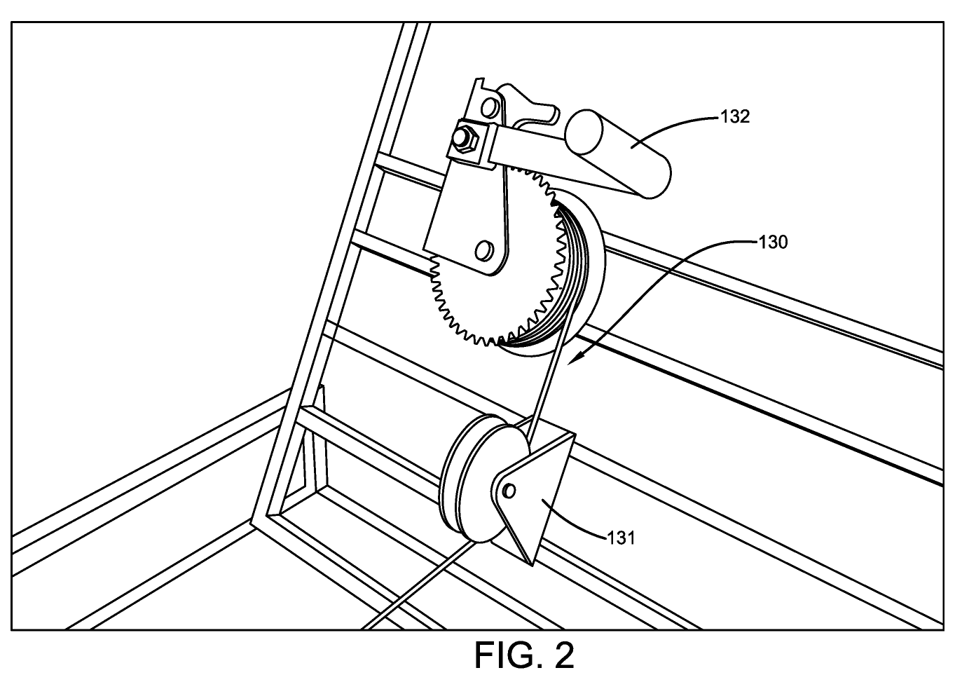

For added functionality, the device 100 is comprised of a winch system 130 that assists in lifting, loading, and unloading heavy items from the frame 102. The winch system 130 can be operated manually through a hand crank 132 and at least one pulley 131 (as seen in FIG. 2) or through a motorized mechanism 134 (as seen in FIG. 1) controlled via handle-mounted buttons 136 or other similar controls. A retractable support stand 138 is integrated into the frame 102 to stabilize the cart when using the winch system 130, preventing unwanted movement during loading operations. A set of removable anchor points 139 such as but not limited to clips, attachment rings, openings, etc. are positioned along the frame 102 to allow users to secure cargo effectively during transport. The winch system 130 may be comprised of at least one cable 141 and at least one fastener 142 such as but not limited to a loop, a clip, a clamp, etc. to allow the cable 141 to be attached to various objects/items.

To further enhance versatility, the cart includes a built-in tow hitch 140 (as seen in FIG. 1), enabling attachment to ATVs, UTVs, or other vehicles for long-distance transport. A quick- release tow hitch mechanism 143 allows for easy attachment and detachment without requiring tools.

By reducing physical strain, improving mobility across rough terrain, and offering motorized assistance for effortless transport, the motorized electric cart device 100 provides a reliable solution for outdoor enthusiasts, hunters, farmers, and individuals needing a heavy-duty transport system.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein "motorized electric cart device" and "device" are interchangeable and refer to the motorized electric cart device 100 of the present invention.

Notwithstanding the forgoing, the motorized electric cart device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the motorized electric cart device 100 as shown in the FIGS. are for illustrative purposes only, and that many other sizes and shapes of the motorized electric cart device 100 are well within the scope of the present disclosure. Although the dimensions of the motorized electric cart device 100 are important design parameters for user convenience, the motorized electric cart device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term "includes" is used in either the detailed description or the claims, such term is intended to be inclusive in a manner similar to the term "comprising" as "comprising" is interpreted when employed as a transitional word in a claim.

What is claimed is:

1. A motorized electric cart device comprising:a frame comprising a bottom wall;a rear wheel;a front wheel comprised of a locking mechanism;a handle attached to the frame;a motorized drive system powered by an electric motor, the motorized drive system configured to drive the rear wheels and activate via a handle-mounted control;a rechargeable battery electrically connected to the motorized drive system;a retractable support stand integrated into the frame; anda winch system.

2. The motorized electric cart device of claim 1, wherein the front wheel is comprised of a puncture-resistant tire.

3. The motorized electric cart device of claim 1, wherein the rear wheel is comprised of a puncture-resistant tire.

4. The motorized electric cart device of claim 1, wherein the winch system is comprised of a cable comprised of a fastener.

5. The motorized electric cart device of claim 4, wherein the fastener is comprised of a loop, a clip, or a clamp.

6. The motorized electric cart device of claim 1, wherein the frame is comprised of an anchor point.

7. The motorized electric cart device of claim 1, wherein the handle-mounted control is comprised of a lever, a button, or a throttle.

8. The motorized electric cart device of claim 1 further comprised of a battery level indicator.

9. A motorized electric cart device comprising:a frame comprising a corrosion-resistant coating, a bottom wall, and a side wall attached to the bottom wall;a rear wheel;a front wheel capable of pivoting 360 degrees relative to a vertical axis of the front wheel, the front wheel comprising a locking mechanism;a handle attached to the frame, the handle comprising a textured grip;a motorized drive system powered by an electric motor, the motorized drive system configured to drive the rear wheels and activate via a handle-mounted control;a rechargeable battery electrically connected to the motorized drive system;a winch system comprising a hand crank and a pulley;a retractable support stand integrated into the frame; anda tow hitch connected to the frame.

10. The motorized electric cart device of claim 9, wherein the tow hitch is comprised of a quick-release mechanism.

11. The motorized electric cart device of claim 9, wherein the winch system is comprised of a cable comprised of a fastener.

12. The motorized electric cart device of claim 11, wherein the fastener is comprised of a loop, a clip, or a clamp.

13. The motorized electric cart device of claim 9, wherein the frame is comprised of an anchor point.

14. The motorized electric cart device of claim 9 further comprised of a battery level indicator.

15. A motorized electric cart device comprising:a frame comprising a corrosion-resistant coating, a bottom wall, and a side wall attached to the bottom wall;a rear wheel;a front wheel capable of pivoting 360 degrees relative to a vertical axis of the front wheel, the front wheel comprising a locking mechanism;a handle attached to the frame, the handle comprising a textured grip;a motorized drive system powered by an electric motor, the motorized drive system configured to drive the rear wheels and activate via a handle-mounted control;a rechargeable battery electrically connected to the motorized drive system;a winch system comprising a motorized mechanism;a retractable support stand integrated into the frame; anda tow hitch connected to the frame.

16. The motorized electric cart device of claim 15, wherein the tow hitch is comprised of a quick-release mechanism.

17. The motorized electric cart device of claim 15, wherein the winch system is comprised of a cable comprised of a fastener.

18. The motorized electric cart device of claim 17, wherein the fastener is comprised of a loop, a clip, or a clamp.

19. The motorized electric cart device of claim 15, wherein the winch system is controlled via a button.

20. The motorized electric cart device of claim 15, wherein the frame is comprised of an anchor point.
